(19) United States
(12) Patent Application Publication
(10) Pub. No.: US 2015/0070195 A1
(43) Pub. Date: Mar. 12, 2015

(54) METHOD AND SYSTEM TO REDUCE BRAKING FOR STOP LIGHTS

(71) Applicant: FORD GLOBAL TECHNOLOGIES, LLC, Dearborn, MI (US)

(72) Inventors: David William Gaines, Farmington, MI (US); Peter T. Mueller, Farmington Hills, MI (US)

(73) Assignee: FORD GLOBAL TECHNOLOGIES, LLC, Dearborn, MI (US)

(21) Appl. No.: 14/023,633

(22) Filed: Sep. 11, 2013

(51) Int. Cl. G08G 1/0967

(52) U.S. Cl. CPC G08G 1/0967
USPC 340/932

(57) ABSTRACT

A vehicle includes a powertrain, a brake, and a controller configured to anticipate an impending stoplight change, predict a status of a stoplight that will occur when the vehicle arrives at the stoplight, and display the prediction.

### BACKGROUND

This application relates generally to vehicle operation on the road and, more particularly, to improved mileage during vehicle operation.

A driver commonly encounters stop lights at intersections that require a driver to stop when the light is red. To do so, a vehicle typically comes to a full stop and starts up again before encountering the next red light. Such start and stop motion reduces gas mileage and causes wear and tear on the powertrain. Oftentimes, stoplights are timed to optimally flow traffic based on an assumption that the vehicle is traveling at the marked speed limit. However, such is not always the case and cars can travel city streets with much frustrating, time consuming, and costly vehicle starts and stops.

As such, there is a need to reduce or eliminate the amount of braking required when traversing streets with stoplights.

### SUMMARY

A vehicle includes a powertrain, a brake, and a controller configured to anticipate an impending stoplight change, predict a status of a stoplight that will occur when the vehicle arrives at the stoplight, and display the prediction.

A method includes anticipating an impending stoplight change of a stoplight, predicting in realtime a status of a stoplight change that will occur when the vehicle reaches the stoplight, and displaying the predicted status to a driver.

A non-transitory computer-readable medium tangibly embodying computer-executable instructions comprising steps to anticipate an impending stoplight change, predict a status of a stoplight that will occur when a vehicle arrives at the stoplight, and display the prediction to a driver of the vehicle.

### BRIEF DESCRIPTION OF THE DRAWINGS

FIG. 1 illustrates a vehicle that includes features that are incorporated into the disclosed system and method;

FIG. 2 illustrates a dashboard of a vehicle;

FIG. 3 is a scenario shown from the vantage point of a driver that is positioned in a vehicle; and

FIG. 4 is a method or algorithm implemented in a vehicle, according to one embodiment.

### DETAILED DESCRIPTION

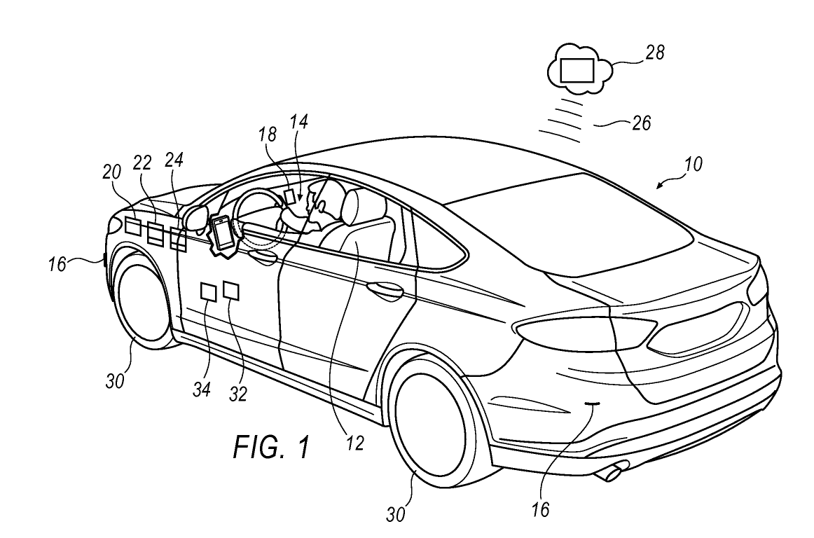

FIG. 1 shows a vehicle 10 having features that are incorporated into the disclosed system and method. Vehicle 10 is illustrated as a typical 4-door sedan, but may be any vehicle for driving on a road, such as a compact car, a pickup truck, or a semi-trailer truck, as examples. Vehicle 10 includes a seat 12 for positioning a driver. Vehicle 10 includes a dashboard 14 that typically includes control buttons or switches for activating various devices on vehicle 10. A steering wheel is positioned such that the driver can steer vehicle 10 while driving.

Vehicle 10 includes a number of features, which include but are not limited to an airbag system, various sensors 16 (such as cameras or distance sensors such as radar devices) throughout vehicle 10, an audio/visual system 18, a GPS 20, and a communication system 22 that includes but is not limited to a WiFi system, an embedded modem, and a dedicated short-range communication (DSRC) system. A DSRC uses one-way or two-way short- to medium range wireless communication channels specifically designed for automotive use and a corresponding set of protocols and standards. A controller or computer or computing device 24 is positioned within vehicle 10, which provides any number of features that include controlling engine and other vehicle parameters, monitoring vehicle operation (safety devices, tire pressure, etc.), interfacing with the driver via the audio/visual system 18, monitoring vehicle position via GPS 20, and providing map and directions to the driver using GPS information, to name a few. The audio and/or visual device 18 may provide warning to a driver or other occupant of a car of a hazard, for instance, may inform the driver of driving instructions, or may provide other features.

Communication system 22 is configured to operate wirelessly with systems external to vehicle 10. In one embodiment, signals are sent wirelessly 26 external to the vehicle, such as to a “cloud computing” device or collection of computers or computing devices 28. Signals may also be sent from communication system 22 via the WiFi system, the embedded modem, or DSRC to other devices external to the vehicle.

Vehicle 10 includes, in one embodiment, a powertrain that includes an engine and power transfer components that include a driveshaft and transmission that convey power to the wheels 30. The engine may be any engine such as an internal combustion engine, a hybrid electric vehicle, or an all-electric vehicle, as examples. Power and braking of vehicle 10 are controlled by an accelerator 32 and a brake pedal 34 that are positioned beneath the driver, as commonly known.

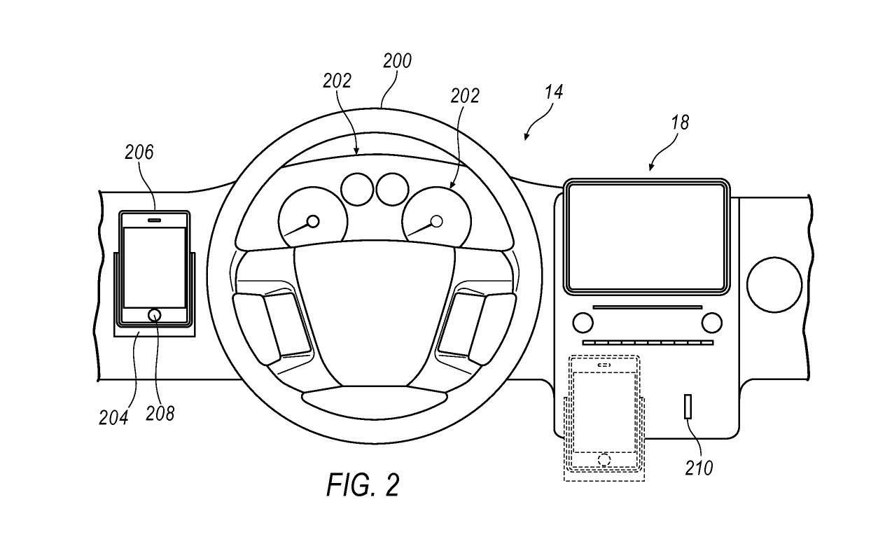

Referring to FIG. 2, dashboard 14 includes a steering wheel 200 and instruments 202 that display vehicle speed, engine speed (e.g., in a tachometer), and the like. Dashboard 14 includes a holder 204 to which a cellphone or cellular telephone 206 is attached. Holder 204 includes any device for holding cellphone 206, such as a clamping device, Velcro, or a device with slots into which cellphone 206 slides, as examples. In an alternative embodiment, holder 204 is not provided and cellphone 206 may be simply placed in the vehicle next to the driver.

In addition to conventional cellphone communication capability (e.g., for telephone calls), cellphone 206 includes a wireless communication device such as Bluetooth or other known methods for communicating with a local device, such as computing device 24 of vehicle 10. Such may be useful for sending music or other information for use on a sound system of vehicle 10, or for communicating with a safety system of vehicle 10, as examples.

Cellphone 206, in one embodiment, is a “smartphone” that is capable of executing software applications, or “apps” that interact with the internet via a touchscreen or other known methods. Cellphone 206 includes a camera 208 and at least one of a keypad and display. As such, a driver or other occupant of a vehicle may communicate wirelessly with computers that are external to the vehicle using computing device 24 and interfacing therewith by using an “app” on cellphone 206, and/or by using audio/visual system 18. Such communication may be with an icon-driven touchscreen, voice-recognition, or by using a text feature, as examples. Communication may be via computing device 24 or cloud or computing devices 28, or to another computer.

That is, an occupant of a vehicle may communicate with computers external to the vehicle via any number of means, including but not limited to a cell phone and/or via a communication system that is part of the vehicle and may be incorporated into a dashboard thereof. Communication is wireless and two-way and may include cloud computing devices and/or a computer device affiliated with a business or industry.

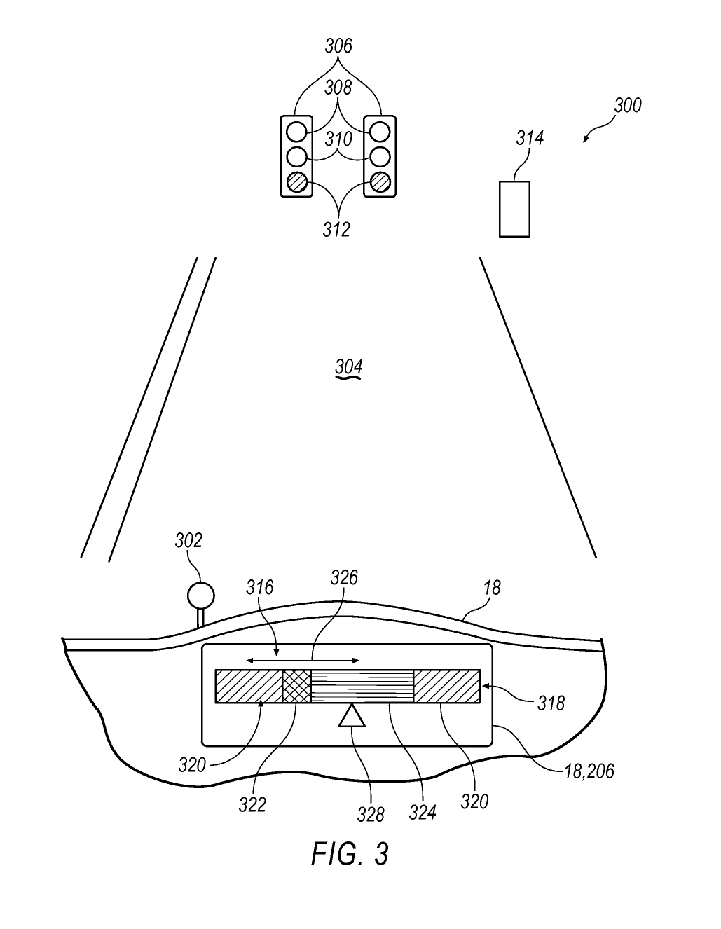

Referring to FIG. 3, a scenario 300 is shown from the vantage point of a driver that is positioned in a vehicle, such as vehicle 10 of FIG. 1. Dashboard 14 is shown that includes a display, which may be a display of audio/visual system 18, or of cellphone 206. A camera 302 or “dashcam” is positioned to obtain video images of scenario 300, which includes road 304 and traffic lights 306. Camera 302 is coupled to controller 24, which processes the visually obtained information collected from the camera 302, according to one embodiment.

Traffic lights 306, shown off in the distance and within scenario 300, are conventional traffic lights that include visual/colored directions to drivers that approach the traffic lights 306. As is commonly known, traffic lights include a red light 308, a yellow light 310, and a green light 312. Red and yellow lights 308, 310, are not lighted in the illustrated example, but green light 312 is lighted, indicating to drivers passing through the intersection to proceed through the intersection.

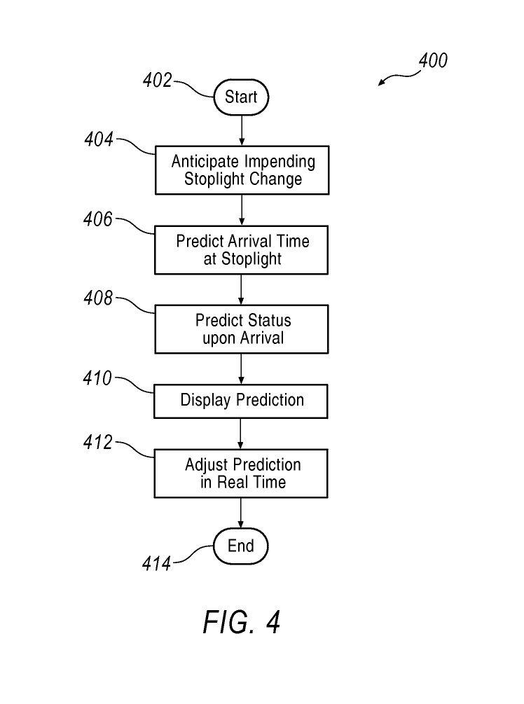

Referring to FIG. 4, a method or algorithm 400 is shown that may be implemented in a vehicle, such as vehicle 10 and consistent with the scenario 300 of FIG. 3, according to one embodiment. Method 400 starts at step 402, and at step 404 any impending stoplight change is anticipated. Such anticipation can be via any number of methods that include but are not limited to timing the changes (as seen through a camera such as the dashboard camera 302 or through sensors 16 positioned on the front of the vehicle 10, in which visual data is obtained in the distance of the lights 306 as they change as the vehicle 10 approaches) or by accessing a signal control box 314 to obtain information via a stop light control circuit that controls lights 306, as shown in FIG. 3. Access to the signal control box 314 may be directly via a wireless signal transmitted from the control box 314, or may be via a larger computing network that, in one example, includes timing signals made more widely available to drivers, such as to cloud or computing devices 28.

Regardless of the method of conveying or obtaining signal timing, controller 24 of vehicle 10 thereby obtains an indication of the anticipated signal change of the traffic lights 306. Controller 24 is also able to obtain a current distance between vehicle 10 and traffic lights 306 via a number of means that include but are not limited to sensors 16 positioned external to the vehicle 10, or camera 302 positioned on dashboard 14. The distance may be determined via direct distance determination using the sensors 16 and/or camera 302, or may be determined using a GPS system, such as GPS 20 of vehicle 10. Controller 24, having access to the vehicle speed via known operating parameters of the vehicle 10, thereby predicts at step 406 an arrival time at traffic lights 306. As such, based on the anticipated impending stoplight change determined at step 404 and based on the predicted arrival time determined at step 406, the method thereby predicts the status of the stoplight, when the vehicle is predicted to arrive, at step 408. As can be appreciated, the predicted arrival time at step 406, and thereby the predicted status of the stop light at step 408, are dependent on a number of parameters that include but are not limited to the anticipated stoplight change, the current speed of the vehicle, the terrain on which the vehicle is travelling (for instance if travelling up or down a steep hill, such change in vehicle speed may be anticipated), and weather conditions (heavy rain, snow, etc.).

At step 410, the prediction of the status of the stoplight upon arrival is displayed to the driver. According to one embodiment, the display to the driver is illustrated in FIG. 3. Referring to FIG. 3, an illustration 316 is shown having a bar 318 that, in illustrated embodiment is a color bar having colors that correspond to those of the traffic light. That is, bar 318 includes color areas of green 320, yellow 322, and red 324. In this embodiment, bar 318 generally corresponds along a length 326 to time durations. The time durations correspond to the amount of time that each light 308, 310, and 312 is anticipated to be at their respective colors, as determined at step 404. That is, at step 404, not only does controller 24 anticipate the color change, but also determines the pattern and time duration anticipated of the lights 308, 310, and 312, which are displayed for the driver having lengths that generally correspond to the anticipated light changes. It is contemplated, however, that the above embodiment describing bar 318 having colored areas 320, 322, and 324 is but one embodiment, and the disclosure is not limited as such. For instance, as another example, the time to the start and end of a green light could be displayed, or the colors could be changed to black and white. In fact, any display or notification to the driver is contemplated in which an impending stoplight change is anticipated and predicted, such that the driver is then made aware of the status and is able to adjust the accelerator or brake, accordingly.

As vehicle 10 approaches an intersection having traffic lights 306, the bar 318 of colors 320, 322, 324 is generated and displayed for the driver. As such, it is contemplated that the pattern of bar 318 varies from traffic light to traffic light, because as is commonly known, traffic lights may have different duration at different locations. Thus, regardless of how the information is obtained regarding the anticipated impending stoplight change at step 404, bar 318 is displayed in realtime for the driver to observe and has light durations shown along length 316.

As shown in FIG. 3, bar 318 shows, proximate thereto, an indicator 328 that is an illustration of what color the traffic lights 306 will be when the vehicle arrives at the intersection. As can be appreciated, indicator 328 is shown in display 316 in what may appear to be a static location, but indicator 328 actually moves along length 326 as the speed of the vehicle changes. Thus, the visual display includes an indicator 328 that corresponds to the predicted status of the light if a speed of the vehicle does not change. In the illustrated embodiment, indicator 328 is shown within the red 324 color, which means that if the vehicle does not alter speed from its current speed, the light will be red upon arrival at the lights 306. Thus, bar 318 is formed having colors 320, 322, and 324 and having lengths of each along length 326 that correspond to the anticipated color pattern that occurs in time with lights 308, 310, and 312 of traffic lights 306. As such, indicator 328, in its current location, is a displayed prediction of scenario 300, during which vehicle 10 approaches traffic lights 306.

However, as the speed of the vehicle changes, the controller dynamically predicts the status based on a current but changing speed of the vehicle, and the computer predicts the status in realtime as the speed of the vehicle changes, corresponding to step 412 of FIG. 4, after which method 400 ends at step 414. That is, as the vehicle speed changes, so too does the indicator or locator 328 along length 326. Further, and as can be appreciated, if the speed of the vehicle is substantially altered, indicator 328 may be moved, in effect, to a point where a yellow light 310 or a green light 312 may be encountered when the vehicle arrives at the traffic lights 306. As such, controller 24 may not only indicate the light that is anticipated when the vehicle reaches the traffic lights 306, but controller 24 is also configured to instruct the driver how to operate one of the accelerator 32 and the brake 34 based on the impending stoplight change, so long as it is within the safety limits of the vehicle and without violating the speed limit or the law in other fashions (i.e., unsafe or reckless operation).

The vehicle above is described as vehicle 10, which is a motorized vehicle. However, it is contemplated that the disclosed subject matter may also be implemented on other types of vehicles, such as a bicycle. In this embodiment, in lieu of using a camera 302 on dashboard 14, a camera may be mounted on a handlebar of a bicycle or on a helmet of a bicycle rider, and placed in communication with a computing device mounted, for instance, on the handlebars. Such a device may include a screen display similar to display 18/206, and may operate in a fashion similar to that described above and with respect to method 400.

Method 400 may be implemented using a hands-free operation using a factory-installed, integrated in-vehicle communications and entertainment system that allows users to make hands-free telephone calls, control music, and perform other functions with the use of voice commands. The system may include applications and user interfaces that are developed in an originally manufactured vehicle and integrated into controller 24, or may be an after-market device.

Thus, by using global positioning data of the current location of a driving car and the position of the next stop light, a distance can be calculated. The current speed of the car can be determined from the on board computer system. The use of known time rate equations can determine when the car will arrive at the next stop light. By using data from when previous cars have stopped and started at each stop light (as seen in, for instance, a camera such as camera 302), data may be collected by directly connecting to the stop light control circuits, or by data collected by a forward looking camera mounted on the dashboard or in the upper corners of the windshield. Thus, the state of the stop light can be determined and displayed for the driver. In an alternative embodiment, a heads up display may be shown to the driver in which, in lieu of bar 318, a pie chart with red, yellow, and green is shown having each color segment proportional to the length of time that color is displayed at the stop light. Thus, in this alternate embodiment, as a driver accelerates or decelerates the pie chart rotates and an arrow indicates the color the stop light will be when you arrive at the light. With this display, a driver could adjust vehicle speed to time the next stop light and avoid having to stop at the light. In another embodiment, separate rotating displays may be included for the left and right hand turn lanes. In yet another embodiment, automatic speed control may be included during which, for instance, cruise control is implemented, that would adjust the speed of the car to ensure not having to stop at the next traffic light.

Computing devices, such as the controller 24, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer-readable media associated therewith (e.g., disks, memories, etc.). A computer program product may comprise such instructions stored on computer-readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, the use of the words “first,” “second,” etc. may be interchangeable.

What is claimed is:

1. A vehicle, comprising:
a powertrain having an accelerator;
a brake; and
a controller configured to:
anticipate an impending stoplight change;
predict a status of a stoplight that will occur when the vehicle arrives at the stoplight; and
display the prediction.

2. The vehicle of claim 1, wherein the controller is further configured to anticipate the impending stoplight change by accessing a stop light control circuit.

3. The vehicle of claim 1, wherein the controller is further configured to anticipate the impending stoplight change by collecting visual data of the stoplight via a camera.

4. The vehicle of claim 1, wherein the controller is further configured to:
determine a current speed of the vehicle; and
predict the status based on at least one of:
the anticipated stoplight change;
the current speed of the vehicle;
a terrain on which the vehicle is travelling; and
weather conditions.

5. The vehicle of claim 1, further comprising a visual display that displays the predicted status, wherein the visual display includes an indicator that corresponds to the predicted status of the light if a speed of the vehicle does not change.

6. The vehicle of claim 1, wherein the controller predicts the status based on a current but changing speed of the vehicle, and the controller predicts the status in realtime as the speed of the vehicle changes.

7. The vehicle of claim 1, wherein the controller is further configured to instruct the driver how to operate one of the accelerator and the brake based on the impending stoplight change.

8. The vehicle of claim 1, wherein the vehicle comprises a motorized vehicle.

9. A method, comprising:
anticipating an impending stoplight change of a stoplight;
predicting in realtime a status of a stoplight change that will occur when the vehicle reaches the stoplight; and
displaying the predicted status to a driver.

10. The method of claim 9, further comprising:
accessing a stoplight control circuit; and
anticipating the impending stoplight change from the stoplight control circuit.

11. The method of claim 9, further comprising:
collecting visual data of the stoplight via a camera; and
anticipating the impending stoplight change from the visual data.

12. The method of claim 9, further comprising:
determining a current speed of the vehicle; and
predicting the status based on at least one of:
the anticipated stoplight change;
the current speed of the vehicle;
a terrain on which the vehicle is travelling; and
weather conditions.

13. The method of claim 9, wherein:
the step of displaying further comprises displaying on a visual display a dynamically predicted status; and
the visual display includes an indicator that corresponds to the predicted status of the light if a speed of the vehicle does not change.

14. The method of claim 13, wherein predicting the status comprises predicting the status based on a current but changing speed of the vehicle, and in realtime as the speed of the vehicle changes.

15. The method of claim 9, further comprising instructing the driver how to operate one of the accelerator and the brake based on the impending stoplight change.

16. A non-transitory computer-readable medium tangibly embodying computer-executable instructions comprising steps to:
anticipate an impending stoplight change;
predict a status of a stoplight that will occur when a vehicle arrives at the stoplight; and
display the prediction to a driver of the vehicle.

17. The non-transitory computer-readable medium of claim 16, further comprising instructions to anticipate the impending stoplight change by accessing a stop light control circuit.

18. The non-transitory computer-readable medium of claim 16, further comprising instructions to anticipate the impending stoplight change by collecting visual data of the stoplight via a camera.

19. The non-transitory computer-readable medium of claim 16, further comprising instructions to display the predicted status on a visual display, wherein the visual display includes an indicator that corresponds to the predicted status of the light if a speed of the vehicle does not change.

20. The non-transitory computer-readable medium of claim 19, further comprising instructions to:
predict the status based on a current but changing speed of the vehicle, and predict the status in realtime as the speed of the vehicle changes; and
instruct the driver how to operate one of the accelerator and the brake based on the impending stoplight change.
